(19) United States
(12) Patent Application Publication
(10) Pub. No.: US 2009/0152988 A1
(43) Pub. Date: Jun. 18, 2009

(54) ULTRASONIC MOTOR

(75) Inventor: Tetsuyuki Sakamoto, Hachioji-shi (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/330,989

(22) Filed: Dec. 9, 2008

(30) Foreign Application Priority Data
Dec. 13, 2007 (JP) 2007-322448

(51) Int. Cl. H02N 2/08

(52) U.S. Cl. 310/323.16

(57) ABSTRACT

An ultrasonic motor produces elliptical vibration by inducing longitudinal vibration and flexural vibration at the same time and drives a driven body by obtaining a drive power from the elliptical vibration. The ultrasonic motor includes a piezoelectric device, friction contact members which are provided on the piezoelectric device so as to transmit the driving force to the driven body, a holding member which is provided on the piezoelectric device and to be positioned and held by a case, a pressure member which presses the holding member so as to bring the friction contact members of the piezoelectric device into a pressure contact with the driven body such that the driven body is capable of being driven by friction, and a first reinforcing member which is fixed to the outer face corresponding to nodes of the longitudinal vibration of the piezoelectric device.

### CROSS-REFERENCE TO RELATED APPLICATIONS

This application is based upon and claims the benefit of priority from prior Japanese Patent Application No. 2007-322448, filed Dec. 13, 2007, the entire contents of which are incorporated herein by reference.

### BACKGROUND OF THE INVENTION

1. Field of the Invention

The present invention relates to an ultrasonic motor for use as, for example, an image vibration correction unit of a digital camera or an actuator of an AF lens or the like.

2. Description of the Related Art

Generally, when a voltage is applied to a piezoelectric device of the ultrasonic motor, longitudinal vibration and flexural vibration are induced, thereby producing an elliptical vibration (oscillation). The ultrasonic motor transmits this elliptical vibration to a driven body via a driver so as to drive the driven body by friction.

A vibrational component using such a piezoelectric device has been disclosed in, for example, Jpn. Pat. Appln. KOKAI Publication No. 8-18379. According to Jpn. Pat. Appln. KOKAI Publication No. 8-18379, the piezoelectric device is formed as a piezoelectric vibrating body so that the piezoelectric vibrating body is sandwiched such that it can be vibrated by a holding frame. The piezoelectric vibrating body is sandwiched by a pair of cases and sealed such that it can be made to vibrate, thereby being prevented from being damaged by external pressure.

It has been demanded that the motor output of an ultrasonic motor having such a piezoelectric device be raised. To raise the motor output, it is necessary to increase a vibration induced by the piezoelectric device by, for example, increasing electric power applied to the piezoelectric device.

The structure disclosed in Jpn. Pat. Appln. KOKAI Publication No. 8-18379 is capable of preventing the piezoelectric device from being cracked by an external force with the holding frame. However, in such a structure, internal stress is concentrated by the vibration of the piezoelectric device. Thus, this structure cannot prevent the piezoelectric device from being cracked by the concentration of the internal stress. That is, when the motor output is increased so that the vibration of the piezoelectric device is intensified, the vibrational velocity resulting in cracks or destruction is raised, thereby inducing the cracking or destruction of the piezoelectric device due to the concentration of the internal stress, which is a problem inherent in this structure.

### BRIEF SUMMARY OF THE INVENTION

The present invention has been achieved in view of the above-described circumstances and an object of the invention is to provide an ultrasonic motor capable of improving a destructive vibrational velocity of a piezoelectric device with a simple structure so as to improve motor output.

The present invention provides an ultrasonic motor, which produces elliptical vibration by inducing longitudinal vibration and flexural vibration at the same time and drives a driven body by obtaining a drive power from the elliptical vibration, comprising: a piezoelectric device, a holding member which is provided on the piezoelectric device and to be positioned and held by a case, a pressure mechanism which presses the holding member to bring the friction contact members of the piezoelectric device into a pressure contact with a driven body such that the driven body can be moved by friction and a first reinforcing member which is fixed to an outer face corresponding to nodes of the longitudinal vibration.

With the above-described structure, the stress concentration portion of the longitudinal vibration of the piezoelectric device is reinforced by the first reinforcing member. Consequently, the resistance to stress is intensified, durability against vibration of the piezoelectric device is improved, prevention of cracking or destruction due to vibration is enhanced, and destructive vibrational velocity is improved, so that the piezoelectric device can execute a highly reliable and highly stable frictional drive. Therefore, the highly reliable and highly stable frictional drive can be achieved and with the simple structure, the destructive vibrational velocity of the piezoelectric device can be improved, thereby raising the motor output.

As described above, the present invention enables to provide the ultrasonic motor capable of improving the destructive vibrational velocity of the piezoelectric device with the simple structure so as to raise the motor output.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plane view showing the schematic structure of an ultrasonic motor according to an embodiment of the present invention;

FIG. 2 is a plane view of the ultrasonic motor as seen from its side face in FIG. 1;

FIG. 3 is a front view of a piezoelectric device of FIG. 1;

FIG. 4 is a side view of FIG. 3;

FIG. 5 is a plane view of the piezoelectric device of an ultrasonic motor according to another embodiment of the present invention;

FIG. 6 is a side view of FIG. 5;

FIG. 7 is a plane view of the piezoelectric device of an ultrasonic motor according to still another embodiment of the present invention;

FIG. 8 is a side view of FIG. 7;

FIG. 9 is a plane view of the piezoelectric device of an ultrasonic motor according to still another embodiment of the present invention; and

FIG. 10 is a side view of FIG. 9.

### DETAILED DESCRIPTION OF THE INVENTION

Hereinafter, the embodiment of the present invention will be described in detail with reference to the accompanying drawings.

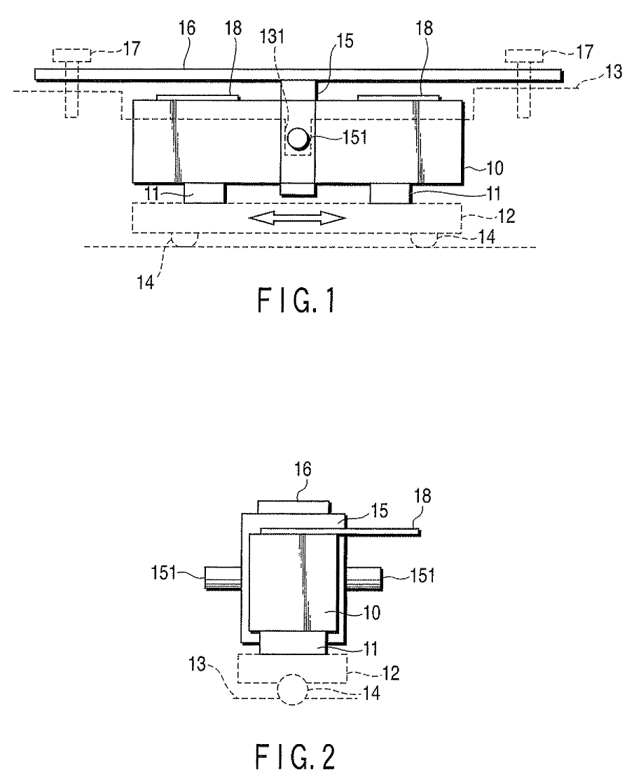

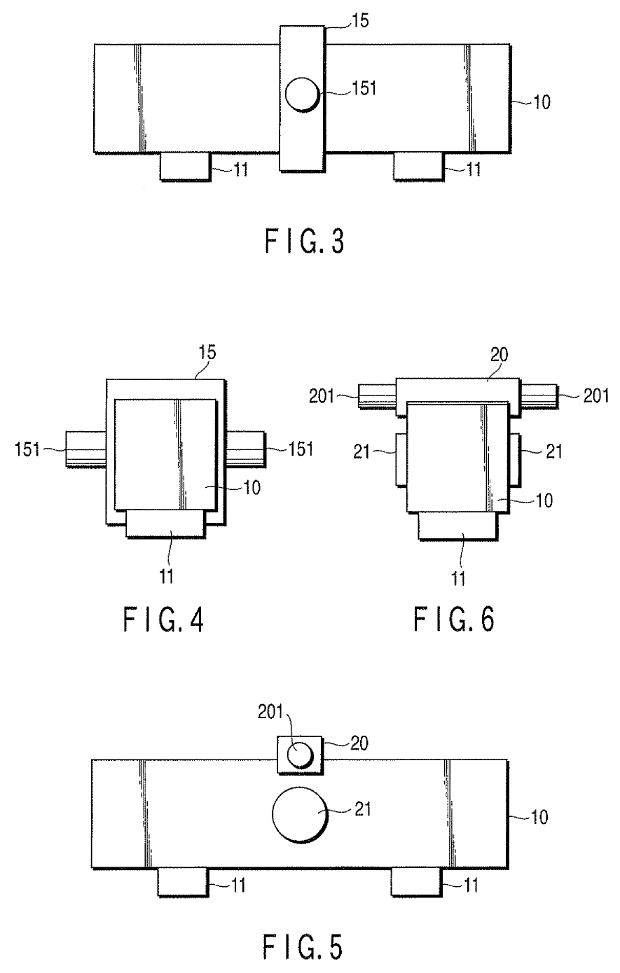

First, this embodiment will be described with reference to FIGS. 1 to 4. FIG. 1 is a plane view showing the schematic structure of an ultrasonic motor according to an embodiment of the present invention. A piezoelectric device 10 is composed (constituted) of a plurality of laminated electrode plates, for example. The piezoelectric device 10 (electrode plate) is formed into a rectangular shape. When a voltage is applied to each electrode plate, the longitudinal vibration and flexural vibration of the piezoelectric device 10 are induced corresponding to the voltage thereby producing the elliptical vibration.

Two friction contact members 11 are fixed to the bottom surface of the piezoelectric device 10, for example, at the antinode (loop) of the flexural vibration with adhesive agent. The friction contact members 11 are spaced at a desired interval. The friction contact members 11 make contact with a driven body 12 (see FIG. 2). The friction contact members 11 are provided on the piezoelectric device 10 so that they make a pressure contact with the driven body 12 by a spring member 16 described later such that they can drive the driven body 12 by friction. At this time, the friction contact members 11 make contact with the driven body 12 so as to transmit a driving force for driving the driven body 12 to the driven body 12. This driving force is a force produced by elliptical vibration, which is induced by longitudinal vibration and flexural vibration at the same time by the piezoelectric device 10. The driven body 12 is provided such that it can be moved freely in directions indicated with arrows with respect to a case 13 of the piezoelectric device 10 via a plurality of rolling members 14 such as a ball.

A substantially square ring shaped frame member 15 is fixed to the piezoelectric device 10, for example, with adhesive agent. The frame member 15 surrounds four external surfaces (outer face) of the piezoelectric device 10 corresponding to nodes of the longitudinal vibration of the piezoelectric device 10, and are fixed to the four external surfaces. This frame member 15 is constructed as a first reinforcing member for the piezoelectric device 10, which reinforces the piezoelectric device 10 on the entire circumference of the substantially square ring shaped frame member 15. If speaking more in detail, the frame member 15 reinforces the node (stress concentration portion) of the longitudinal vibration of the piezoelectric device 10 so as to intensify a resistance to the stress, thereby improving durability against the vibration of the piezoelectric device 10. For example, cylindrical holding portions 151 are provided projectingly at a substantially central portion of both side faces of the frame member 15a. The holding portions 151 are provided on the piezoelectric device 10 so as to constitute a holding member, which is positioned and held by the case 13. The frame member 15 as the first reinforcing member and the holding portion 151 as the holding member are formed integrally.

When the holding portions 151 are inserted into positioning recess portions 131 provided in the case 13, they position and hold the piezoelectric device 10 with respect to the case 13. With this state, an intermediate portion of a spring member 16 is brought into contact with the top portion of the frame member 15 as a pressure member. The spring member 16 is provided within the case 13 so as to have a desired amount of flexure. The spring member 16 is installed within the case 13 through screw members 17 on both end portions of the spring member 16. Consequently, the frame member 15 is urged (pressed) by the spring member 16 so as to press the friction contact members 11 of the positioned and held piezoelectric device 10 to the driven body 12 such that the driven body 12 can be moved by friction. That is, the friction contact members 11 are brought into a pressure contact with the driven body 12 such that the driven body 12 can be driven by friction.

Flexible cables 18 are fixed to the top face side of the piezoelectric device 10. For example, conductive adhesive agent is used for the flexible cables 18. The piezoelectric device 10 is connected to a driving circuit (not shown) through the flexible cable 18. A voltage is applied to the piezoelectric device 10 through this driving circuit. As a result, as described above, the piezoelectric device 10 induces the longitudinal vibration and flexural vibration corresponding to this voltage so as to produce the elliptical vibration. Then, the piezoelectric device 10 obtains a driving force produced by the aforementioned elliptical vibration and transmits this driving force to the driven body 12 through the friction contact members 11.

The frame member 15 is formed of any one of resin material, metal material and ceramics. Speaking in detail, as the metal material, for example, brass having an excellent processability, alloys of beryllium copper, phosphorus bronze and the like having an excellent spring performance, and stainless steel and duralumin having a high stiffness are used. If the frame member 15 is formed of material having a high stiffness such as stainless steel and duralumin, the frame member 15 can be formed thinner and into a smaller size.

As the resin material, for example, epoxy resin, ABS resin, polyphenylene sulfide (PPS) resin, polyether ether ketone (PEEK) resin and the like are used. If the frame member 15 is formed of such resin material, the frame member 15 as the first reinforcing member can be formed into a lighter weight than the metal material and can be injection molded and thus, it is installed (provided) on the piezoelectric device 10 by insert molding. Consequently, by insert molding the frame member 15, the fixing process for the piezoelectric device 10 can be simplified.

As the resin material, reinforced plastic such as liquid crystal polymer (LCP) resin containing filler such as glass fiber and carbon fiber, and PPS resin containing filler such as potassium titanate may be used. If the frame member 15 is formed of such reinforced plastic, the strength, heat resistance and dimensional processing accuracy of the frame member 15 can be improved.

As the ceramics, alumina, zirconia and the like are used. If the frame member 15 is formed of such ceramics, the strength of the frame member 15 can be intensified, so that the frame member 15 can obtain a similar linear expansion coefficient to the piezoelectric device 10. As a result, when the frame member 15 is fixed to the outer surface of the piezoelectric device 10 using thermoplastic adhesive agent, even if the frame member 15 suffers from changes in temperature when the thermoplastic resin is hardened to bond the frame member 15 or changes in temperature of the environment after the thermoplastic resin is hardened, distortion of the adhesive layer is suppressed thereby achieving a simple and high quality fixing of the frame member 15.

With the above-described structure, when a voltage is applied to the piezoelectric device 10 through a driving circuit (not shown), the piezoelectric device 10 induces the longitudinal vibration and the flexural vibration at the same time so as to produce the elliptical vibration, thereby obtaining a driving force produced by this elliptical vibration. This driving force is transmitted to the driven body 12 through the friction contact members 11 and the driven body 12 is driven by friction in directions of arrows with respect to the case 13 through the rolling members 14. Because both the side faces of the piezoelectric device 10 and the top surface of the piezoelectric device 10 corresponding to the nodes of the longitudinal vibration which induces concentration of stress by the longitudinal vibration of the piezoelectric device 10 are reinforced by the frame member 15, the strength of the piezoelectric device 10 is intensified. Consequently, the driven body 12 executes a stable and high quality frictional driving.

In the piezoelectric device 10, the nodes of the longitudinal vibration are reinforced by the frame member 15 so that the durability against the longitudinal vibration is intensified, thereby intensifying destructive vibrational velocity which serves as a standard for formation of cracking or destruction due to concentration of stress accompanied by production of the elliptical vibration. Consequently, the vibrational velocity of the piezoelectric device 10 is raised, thereby intensifying the motor output.

In the ultrasonic motor, the frame member 15 having the holding portions 151 is fixed to the outer surface corresponding to the nodes of the longitudinal vibration of the piezoelectric device 10, which induces the longitudinal vibration and the flexural vibration at the same time so as to produce the elliptical vibration.

Consequently, the stress concentration portion of the longitudinal vibration of the piezoelectric device 10 is reinforced by the frame member 15. Thus, the resistance to stress can be intensified so as to improve the durability against the elliptical vibration of the piezoelectric device 10, so that prevention of cracking or destruction due to the vibration is enhanced, thereby improving the destructive vibrational velocity and achieving a high quality frictional driving. Then, with a simple structure, the destructive vibrational velocity of the piezoelectric device 10 can be improved so as to improve the motor output, thereby achieving a highly reliable and stable frictional drive.

The present invention is not restricted to the above-described embodiment and may be constructed as shown in FIGS. 5 to 10 and the same effect can be expected. In respective embodiments shown in FIGS. 5 to 10, like reference numerals are attached to the same components as the embodiments shown in FIGS. 1 to 4 and detailed description thereof is omitted.

According to the embodiment shown in FIGS. 5 and 6, the holding member 20 supplied with a spring force through the spring member 16 is fixed to the outer face of the top side of the piezoelectric device 10 corresponding to the nodes of the longitudinal vibration of the piezoelectric device 10, for example with adhesive agent. For example, cylindrical projecting portions 201 are provided projectingly on the both end portions of the holding member 20.

When the projecting portions 201 are inserted into the positioning recess portions 131, the piezoelectric device 10 is positioned and held with respect to the case 13. The holding member 20 is in an elastic engagement with the spring member 16 and urged by the spring member 16, so that the friction contact members 11 of the positioned and held piezoelectric device 10 are kept in a pressure contact with the driven body 12 such that the driven body 12 can be moved by friction.

The first reinforcing member 21 formed into a disc shape is fixed substantially in the center of each of both side faces of the piezoelectric device 10 of the outer surface corresponding to the nodes of the longitudinal vibration of the piezoelectric device 10, for example, with adhesive agent. This first reinforcing member 21 is formed of any one of the above-mentioned resin material, metal material and ceramics. The first reinforcing member 21 intensifies reinforcement performance of the piezoelectric device 10 against the concentration of stress when the piezoelectric device 10 vibrates longitudinally, thereby preventing formation of cracking and destruction due to production of the elliptical vibration. According to this embodiment, the holding member 20 and the first reinforcing member 21 are fixed to the piezoelectric device 10 separately.

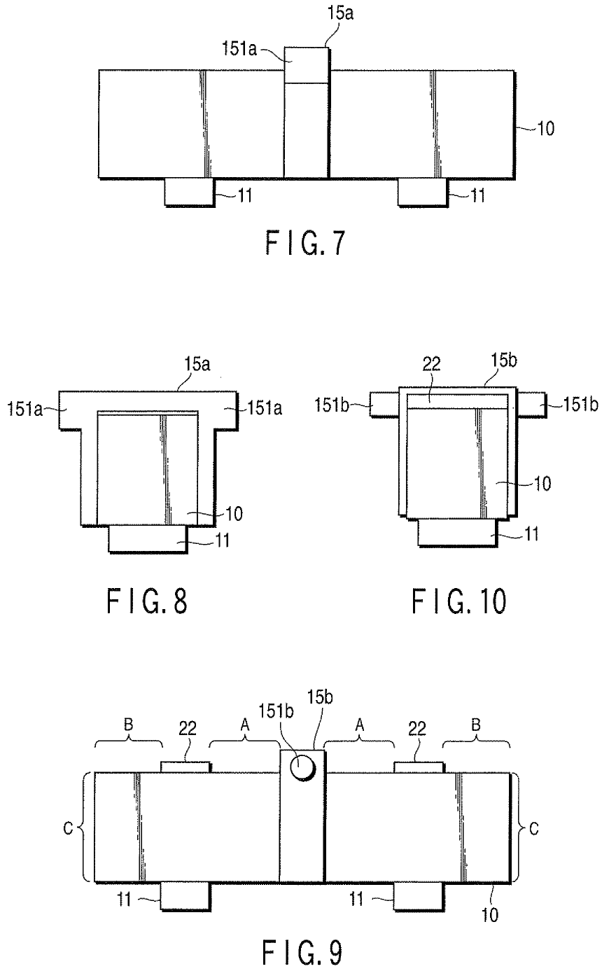

According to the embodiment shown in FIGS. 7 and 8, a substantially H shaped frame member 15a which surrounds the top face and the both side faces of the piezoelectric device 10 of the outer face corresponding to the nodes of the longitudinal vibration of the piezoelectric device 10 is fixed to the top face and the both side faces of the piezoelectric device 10, for example, with adhesive agent. This frame member 15a is constructed as a reinforcing member for the piezoelectric device 10, which reinforces the piezoelectric device 10 with the inside (entire top face and both side faces of the frame member 15a) of the substantially π shaped frame member 15a. Holding portions 151a having a prismatic shape, for example, are provided projectingly on both ends of the top side of the frame member 15. The holding portions 151a are provided on the piezoelectric device 10 so as to constitute a holding member which is positioned and held by the case 13.

When the holding portions 151a are inserted into the positioning recess portion 131, the piezoelectric device 10 is positioned and held by the case 13. With this state, the intermediate portion of the spring member 16 is in an elastic engagement with the top side of the frame member 15a. This spring member 16 urges the frame member 15a so as to bring the friction contact members 11 of the positioned and held piezoelectric device 10 into a pressure contact with the driven body 12 such that the driven body 12 can be moved by friction.

The frame member 15a is formed of any one of the resin material, metal material and ceramics as described above. The frame member 15a intensifies the reinforcement performance of the piezoelectric device 10 against the concentration of stress when the piezoelectric device 10 vibrates longitudinally thereby preventing formation of cracking and destruction due to production of the elliptical vibration.

According to the embodiment shown in FIGS. 9 and 10, a substantially π shaped frame member 15b which surrounds the top face and the both side faces of the piezoelectric device 10 of the outer faces corresponding to the nodes of the longitudinal vibration of the piezoelectric device 10 is fixed to the top face and the both side faces of the piezoelectric device 10, for example, with adhesive agent. This frame member 15b is constructed as a reinforcing member for the piezoelectric device 10, which reinforces the piezoelectric device 10 with the inside (entire top face and both side faces of the frame member 15b) of the substantially π shaped frame member 15b. For example, cylindrical holding portions 151b are provided projectingly on both ends on the top side of the frame member 15. The holding portions 151b are provided on the piezoelectric device 10, thereby constituting a holding member which is positioned and held by the case 13.

When the holding portions 151b are inserted into the positioning recess portion 131, the piezoelectric device 10 is positioned and held by the case 13. With this state, the intermediate portion of the spring member 16 is in an elastic engagement with the top side of the frame member 15b. This spring member 16 urges the frame member 15b so as to bring the friction contact members 11 of the positioned and held piezoelectric device 10 into a pressure contact with the driven body 12 such that the driven body 12 can be moved by friction.

Second reinforcing members 22 are fixed at positions corresponding to the antinode of the flexural vibration of the piezoelectric device 10 on the top side (top face) of the piezoelectric device 10 for example, with adhesive agent. These second reinforcing members 22 are spaced at a desired interval. The second reinforcing members 22 are disposed opposed to the friction contact members 11. The second reinforcing members 22 intensify the reinforcement performance (strength) against the concentration of stress by the flexural vibration of the piezoelectric device 10 so as to prevent formation of cracking and destruction due to production of the elliptical vibration in cooperation with the holding portion 151b. In this case, a flexible cable (not shown) is fixed to any one of areas Ar, B and C shown in FIG. 9. That is, the flexible cable is fixed in area A sandwiched by the second reinforcing member 22 and the frame member 15b or fixed in area B sandwiched by the second reinforcing member 22 and the top face end portion of the piezoelectric device 10 or fixed in area C on both side faces of the piezoelectric device 10. In the meantime, the flexible cable may be fixed in an area in which a plurality of areas A, B, C are combined. That is, as for the connecting style of the piezoelectric device 10 and the flexible cable, the flexible cable may be disposed at a desired position by changing the shape of an electrode inside the piezoelectric device 10 and the connecting style of the piezoelectric device 10 and the flexible cable never limits the fixing position of the second reinforcing member 22.

As described above, the frame member 15b and the second reinforcing member 22 are formed of any one of resin material, metal material and ceramics. When the piezoelectric device 10 induces the longitudinal vibration and the flexural vibration, the frame member 15b and the second reinforcing member 22 intensify the reinforcement performance of the piezoelectric device 10 against the concentration of stress so as to prevent formation of cracking or destruction due to production of the elliptical vibration. The frame member 15b and the second reinforcing member 22 may be formed by combining different materials of the above-mentioned resin material, metal material and ceramics.

The second reinforcing member 22 may be constructed to be fixed to the outer face on the top side of the piezoelectric device 10 corresponding to the antinode of the flexural vibration of the piezoelectric device 10 in the embodiment shown in FIGS. 1 to 4, the embodiment shown in FIGS. 5 and 6 and the embodiment shown in FIGS. 7 and 8 and in any case, the same effect can be expected.

The present invention is not restricted to the above-described embodiments but may be modified in various ways within the scope not departing from the principle of the invention when realizing the invention. Further, the above-described embodiments include aspects of various stages of the invention and other various aspects of the invention can be extracted by combining the disclosed plural components appropriately.

For example, even if some components are eliminated from all the components indicated in the embodiment, if the problem intended to be solved can be solved and the effect intended to be attained is secured, the configuration from which those components are eliminated can be extracted as another aspect of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ultrasonic motor which produces elliptical vibration by inducing longitudinal vibration and flexural vibration at the same time and drives a driven body by obtaining a drive power from the elliptical vibration, comprising:
a piezoelectric device;
friction contact members which are provided on the piezoelectric device so as to transmit the driving force to the driven body;
a holding members which is provided on the piezoelectric device and to be positioned and held by a case;
a pressure member which presses the holding member so as to bring the friction contact members into a pressure contact with the driven body such that the driven body is capable of being driven by friction; and
a first reinforcing member which is fixed to the outer face corresponding to nodes of the longitudinal vibration of the piezoelectric device.

2. The ultrasonic motor according to claim 1, wherein the first reinforcing member and the holding member are formed integrally.

3. The ultrasonic motor according to claim 2, wherein the first reinforcing member is provided on the piezoelectric device by insert molding.

4. The ultrasonic motor according to claim 3ᵣ wherein the second reinforcing member is fixed to the top face corresponding to the antinode of the flexural vibration of the piezoelectric device.

5. The ultrasonic motor according to claim 2, wherein the second reinforcing member is fixed to the top face corresponding to the antinode of the flexural vibration of the piezoelectric device.

6. The ultrasonic motor according to claim 1, wherein the first reinforcing member is provided on the piezoelectric device by insert molding.

7. The ultrasonic motor according to claim 6, wherein the second reinforcing member is fixed to the top face corresponding to the antinode of the flexural vibration of the piezoelectric device.

8. The ultrasonic motor according to claim 1, wherein the first reinforcing member is disposed at least on both side faces of the both side faces and the bottom face of an outer face corresponding to nodes of the longitudinal vibration of the piezoelectric device and the holding member is disposed on the top face of the outer face corresponding to the nodes of the longitudinal vibration of the piezoelectric device.

9. The ultrasonic motor according to claim 8, wherein the first reinforcing member is provided on the piezoelectric device by insert molding.

10. The ultrasonic motor according to claim 9, wherein the second reinforcing member is fixed to the top face corresponding to the antinode of the flexural vibration of the piezoelectric device.

11. The ultrasonic motor according to claim 8, wherein the second reinforcing member is fixed to the top face corresponding to the antinode of the flexural vibration of the piezoelectric device.

12. The ultrasonic motor according to claim 1, wherein the second reinforcing member is fixed to the top face corresponding to the antinode of the flexural vibration of the piezoelectric device.
